(19) United States
(12) Patent Application Publication
(10) Pub. No.: US 2004/0231255 A1
(43) Pub. Date: Nov. 25, 2004

(54) Method of glazing insulated sash frame

(75) Inventor: Arthur Silverman, Warren, NJ (US)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Silver Line Building Products Corp., North Brunswick, NJ (US)

(21) Appl. No.: 10/440,837

(22) Filed: May 19, 2003

(51) Int. Cl. E06B 3/68

(52) U.S. Cl. 52/204.6; 52/204.69; 52/786.1; 52/204.597

(57) ABSTRACT

A method for glazing a sash frame and a sash frame for insulated glass windows are disclosed wherein both sides of the sash frame, are glazed from one side of the sash, eliminating the requirement for flipping the sash during manufacture.

### FIELD OF THE INVENTION

The present invention relates to methods of constructing insulated glass windows, and more particularly to an improved manufacturing process for insulated glass window sash frames. More particularly, the present invention also relates to a novel insulated glass window itself.

### BACKGROUND OF THE INVENTION

In most insulated glass (“IG”) windows, a frame made of a weather resistant substance such as, for example, wood, aluminum, polyvinyl chloride (“PVC”), composites and the like is employed. In the past, parallel sheets of glass have been attached to spacer bars, and these spacer bars have then been incorporated into the overall window sash. The spacer bar itself has been prepared from a hollow, roll-formed flat sheet of metal, formed into a channel or tube, with the glass panes affixed to the sides of the spacer bar by means of conventional sealants.

There has been developed, however, integral sash frames which incorporate such spacer bars as part of their structure, such as those disclosed in U.S. Pat. No. 6,286,288 to France.

These integral sash frames may thus be manually constructed from individual side pieces, bonded together and stabilized through the introduction of glass panes, or may be a prefabricated sash frame requiring only bonding and placement of glass panes thereon. The frame disclosed in U.S. Pat. No. 6,286,288, for example, provides a prefabricated PVC sash frame employing exposed glazing surfaces on the two outer surfaces of the sash frame. A bonding adhesive is placed on one outer surface of the sash frame, and a glass pane is placed over the bonding adhesive in such a manner that the glass is not required to touch the PVC material, and is allowed to set. A bonding adhesive is then placed on the other outer surface of the second viewing surface of the sash frame and a glass pane is similarly placed and set.

In any case, even in the case of these integral sash frames with spacer bars, the glazing process is a multiple step process requiring frequent manipulation of the sash frame and window components. First, a sash is created from its constituent components, as is well known in the art, with a first viewing surface and a second viewing surface. Then, the sash is laid on its first viewing surface. A bonding agent is applied to the second viewing surface, and a glass pane is mounted on the second viewing surface. After the glass pane has set, or with the help of a securing mechanism such as a clamp, glazing bead or clip, the entire sash must be turned over so as to lie on its second surface. A bonding agent is then applied to the first viewing surface, and a glass pane is mounted on the first viewing surface. Securing mechanisms may again be employed. Therefore, even in the embodiment shown in FIG. 3 of U.S. Pat. No. 6,286,288, while two of the glazing legs (62 and 64) face in the same direction, the glazing legs which comprise the two viewing surfaces of the sash itself (60 and 62) face in opposite directions; i.e., both face outwardly from the sash, as has been the case in this art.

All of the known methods for producing these IG units in which the spacer is an integral part of the sash frame require the sash to be “flipped” from its first side to its second side at some point in processing so that both viewing surfaces of the sash can be glazed.

This flipping step, although a long-standing part of the creation of IG windows in which the spacer is an integral part of the sash frame, is a hindrance to automated manufacturing and consistent output. First, flipping of the window is not easily performed in an inexpensive manner except when done manually. Second, the flipping step can deleteriously effect the stability of any glazing completed before flipping, and can cause loosening of contact between the glass and adhesive, or can cause misalignment of glass on the sash. In some cases, flipping can result in damage to the glazed surface when the glass on the first treated side is flipped and comes into contact with manufacturing tools, surfaces or tables.

On the other hand, in some commercial processes, where a separate spacer is first constructed and then incorporated into the frame, it may be possible to construct the spacer without a flipping step. For example, the first pane of glass may be laid down first, and then affixed to the spacer, with the second pane of glass then applied thereto. While this process may not literally require flipping, this is because it applies to a spacer and not a frame itself, and it nevertheless does not permit the window panes to both be applied from the same side even of the spacer, much less from the same side of a sash frame. This, in turn, makes the overall method far less valuable and efficient.

### SUMMARY OF THE INVENTION

In accordance with the present invention, these and other objects have now been realized by the invention of an improved method of glazing an IG window sash, and of an insulated sash frame produced by such a method. In one embodiment, the glazing method of the present invention permits manufacture of IG windows which include integral spacers without the need for flipping the sash frame during glazing.

In one embodiment of the present invention, the glazing method permits automated glazing of IG window sash frames without the need for the expense of a mechanical flipping apparatus or the manual flipping of these sashes.

In another embodiment of the present invention, the glazing method permits mounting of all required glass panes in a sash frame, and setting of all required glass planes, in few steps, so as to substantially reduce the time necessary for the glazing step.

In another embodiment of the present invention, a method for glazing an insulated sash frame for an insulated glass window is disclosed, comprising laying an insulated sash frame having an outer surface on a first viewing side of the insulated sash frame, the insulated sash frame including the first viewing side, a second viewing side, and a plurality of bonding recesses all opened toward the second viewing side of the insulated sash frame; applying a bonding material to each of the plurality of bonding recesses from the second viewing side; and setting a glass piece on each of the plurality of bonding recesses from the second viewing side.

In another embodiment of the method of the present invention for glazing an insulated sash frame for an insulated glass window, the method includes varying the distance between each of the plurality of bonding recesses and the outer surface of the insulated sash frame.

In accordance with another embodiment of the method of the present invention, the plurality of bonding recesses include a first bonding recess on the first viewing side of the insulated sash frame, the first bonding recess facing the second viewing surface of the sash frame, and a second bonding recess on the second viewing side of the insulated sash frame, the second bonding recess facing the second viewing surface of the sash frame.

In accordance with yet another embodiment of the method of the present invention, the method comprises the steps of laying an insulated sash frame on a first viewing side of the insulated sash frame, the insulated sash frame including the first viewing side, a second viewing side, a first bonding recess on the first viewing side, and a second bonding recess on the second viewing side, the first and second bonding recesses open to the second viewing side of the insulated sash frame; applying a bonding material to the first bonding recess of the insulated sash frame from the second viewing side; applying a bonding material to the second bonding recess of the insulated sash frame from the second viewing side; setting a glass piece on the first bonding recess of the insulated sash frame from the second viewing side; and setting a glass piece on the second bonding recess of the insulated sash frame from the second viewing side.

In accordance with another embodiment of the present invention, an insulated sash frame has been discovered for an insulated glass window, comprising a first viewing side; a second viewing side; a first bonding recess on the first viewing side, the first bonding recess open to the second viewing side, the first bonding recess having a first elevation from the base; and a second bonding recess on the second viewing side, the second bonding recess open to the second viewing side and having a second elevation from the base, the first and second elevations being different. In a preferred embodiment, the first elevation is greater than the second elevation. In another embodiment, a first bonding material is applied to the first bonding recess; and a second bonding material is applied to the second bonding recess. In a preferred embodiment, a first glass pane is coupled to the first bonding recess by means of the first bonding material, and a second glass pane is coupled to the second bonding recess via the second bonding material.

### BRIEF DESCRIPTION OF THE DRAWINGS

FIG. 1 is a side, elevational, cross-sectional view of one embodiment of a sash of the present invention;

FIG. 2 is a side, elevational, cross-sectional view of the sash of the present invention shown in FIG. 1;

FIG. 3A is a side, elevational, cross-sectional view of one embodiment of a hollow sash of the present invention;

FIG. 3B is a side, perspective view of the embodiment of a hollow sash of the present invention shown in FIG. 3A;

FIG. 4A side, elevational, cross-sectional view of another embodiment of a hollow sash of the present invention; and

FIG. 4B is a side, perspective view of the embodiment of the hollow sash of the present invention shown in FIG. 4A.

### DETAILED DESCRIPTION

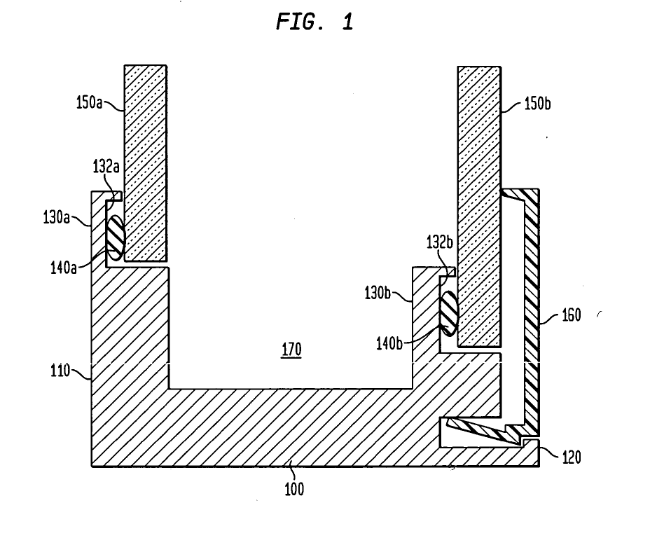

FIG. 1 shows a cross-sectional view of one embodiment of a sash of the present invention. An insulated sash frame 100, made of a weather and moisture resistant material such as, for example, metals, such as steel and aluminum, and plastics such as PVC, polypropylene, plastic composites, and the like, is formed into a perimeter around a geometrical form of the window pane to be formed. In one embodiment, the sash perimeter is rectangular, but the form may be square, circular, elliptical, or irregular in shape as the final window requires. In each of these cases, however, the same cross section of the insulated sash frame 100 may advantageously be used.

The insulated sash frame 100 includes two viewing sides, represented in FIG. 1 as a first viewing side 110 and a second viewing side 120. The first viewing side 110 and the second viewing side 120 form substantially parallel viewing surfaces based on the major geometrical region formed by the perimeter of the insulated sash frame 100.

The insulated sash frame 100 also includes a plurality of bonding recesses 130. The bonding recesses 130 include a first bonding recesses 130a associated with the first viewing surface 110, and a second bonding recess 130b associated with the second viewing surface 120. Both of the bonding recesses 130 are oriented to have a bonding surface 132 directed towards the second viewing surface 120. In the embodiment of FIG. 1, the two bonding surfaces 132a and 132b are on the first bonding recess 130a and second bonding recess 130b respectively, and each of the bonding surfaces 132a and 132b are oriented towards the second viewing surface 120. As described in detail below, each bonding recess 130 is located at a distance above the base of the insulated sash frame 100 which is directly proportional to its distance from the second viewing surface.

At least one bonding material 140, such as the various sealant materials used commercially for such purposes, including silicone adhesives, hot melt butyl material, modified polyurethane sealants, and the like, are applied to each bonding surface 132 of each bonding recess 130. Preferably, the bonding material 140 is applied to each of the bonding surfaces 132. A pane 150, which can be glass, plastic, or another clear viewing material, is also applied to the bonding recesses 130, after application of the bonding material 140, in order from the first viewing side 110 to the second viewing side 120.

Thus, a first bonding material 140a can be applied to the first bonding surface 132a of the first bonding recess 130a, upon which a first glass pane 150a is mounted, followed by application of a second bonding material 140b to a second bonding surface 132b of a second bonding recess 130b, upon which a second glass pane 150b is mounted. These bonding materials can be applied by automated equipment at a first station along the assembly line, which preferably rapidly applies a continuous bead of the bonding material about the entire periphery of the respective binding recess 130 and the sash frame.

Alternatively, bonding materials 140a and 140b are applied in tandem to the first bonding surfaces 132a and 132b of the first bonding recess 130a and second bonding recess 130b at the first viewing surface 110 and second viewing surface 120, respectively. Then a first glass pane 150a and second glass pane 150b are mounted on the first bonding recess 130a and second bonding recess 130b by way of the first bonding material 140a and second bonding material 140b, respectively. In an automated commercial process this glass mounting step can be rapidly carried out at a second station along the assembly line.

Once the pane 150b has been mounted, a glazing bead 160 is applied to the sash 100, from the direction of the second viewing surface and abutting the second viewing surface 120 and the second pane 150b to provide a finished, even look to the sash, hide the junction of the bonding recess 130b and the glass pane 150b, and protect the bonding material 140b between the bonding surface 132b of the bonding recess 130b and the glass pane 150b from the environment.

In this manner, the steps of glazing the sash 100 can be accomplished either simultaneously or serially, so long as the actual mounting of panes is performed starting from the first viewing surface and moving towards the second viewing surface. For example, each step may be performed simultaneously for all bonding recesses 130 before moving to the next step, whereas in serial each step may be performed for each bonding recess 130a before moving to the next bonding recess 130b.

Once the glass panes are set, the resulting sash 100 includes a central insulating region 170 which provides thermal insulation between the first viewing surface 110 and second viewing surface 120 of the window sash 100.

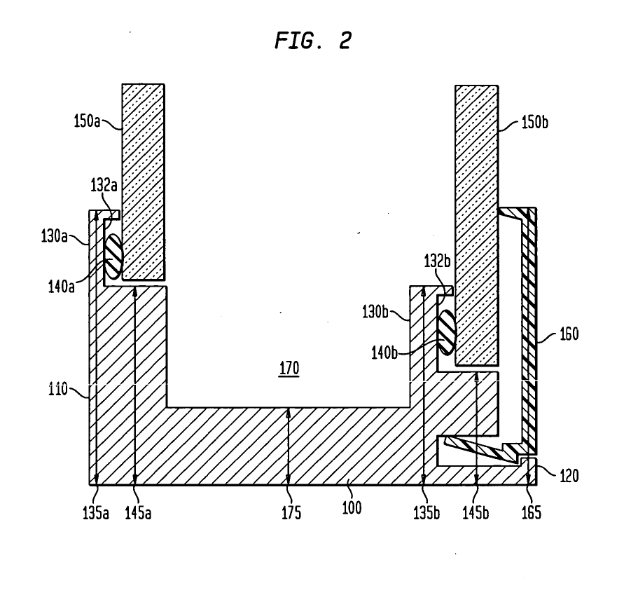

FIG. 2 shows a cross-sectional view of one embodiment of a sash of the present invention, including relative dimensional callouts that are not necessarily to scale. Each bonding recess 130 has an associated bonding recess maximum elevation, 135a and 135b, as measured from the base of the sash frame 100, the bonding recess maximum elevation defined as, for example, the distance between the base of the insulated sash frame 100 and the top of the bonding recess 130. For each bonding surface 132, the bonding surface 132 also has a bonding recess minimum elevation 145 defined as, for example, the distance between the base of the insulated sash frame 100 and the base of the bonding surface 132. As can thus be seen, the height of the bonding recess 130 itself is the difference between the bonding recess maximum elevation and the bonding recess minimum elevation.

The central insulating region 170 has an insulating region height 175 defined as, for example, the distance between the base of the insulated sash frame 100 and the bottom of the region constituting the central insulating region 170. Similarly, the glazing bead 160 has a glazing bead elevation 165 defined as, for example, the distance between the base of the insulated sash frame 100 and the top of the glazing bead 160. While for aesthetic purposes this glazing bead elevation 165 may be the same as the bonding recess maximum elevation 135a on the opposite viewing side, this does not necessarily have to be the case, and these two elevations can have different elevations.

Based on these values, and the selected geometry of the sash, the preferred relative dimensions of each bonding recess, bonding surface, and glazing bead can be readily determined. For example, if a first viewing surface 110 has a bonding recess 130a with a bonding recess maximum elevation 135a of 4 inches, and a bonding recess minimum elevation of 3 inches, then the height of the bonding recess itself would be 1 inch. As for the bonding recess maximum elevation 135b for second viewing surface 120, this distance will be defined, for example, by:

135b=145a−ε (Eq. 1)

As used above, ε represents a margin of error added to Equation 1 wherein 0≦ε≦about 1 inch, for example, to ensure that panes nearer to the first viewing surface can easily be mounted from the second viewing surface. Thus, while it is possible that the elevation 135b can be equal to that of 145a, it is most preferable that the bonding recess maximum elevation 135b be less than the bonding recess minimum elevation 145a, again for the purposes discussed above. When intermediary viewing surfaces between the first viewing surface 110 and second viewing surface 120 are included in the sash frame (to create, for example, triple glazed windows), then the formula of Equation one is simply applied to each viewing surface recursively, beginning with the first viewing surface. In each such case, however, it is essential for the purposes of the present invention that all of the bonding recesses 130 face in the same direction, and in the case of FIG. 1 towards the second viewing surface 120. Other equations for determination can similarly be developed based on different measures of spacing and as required by varying window design and sash material.

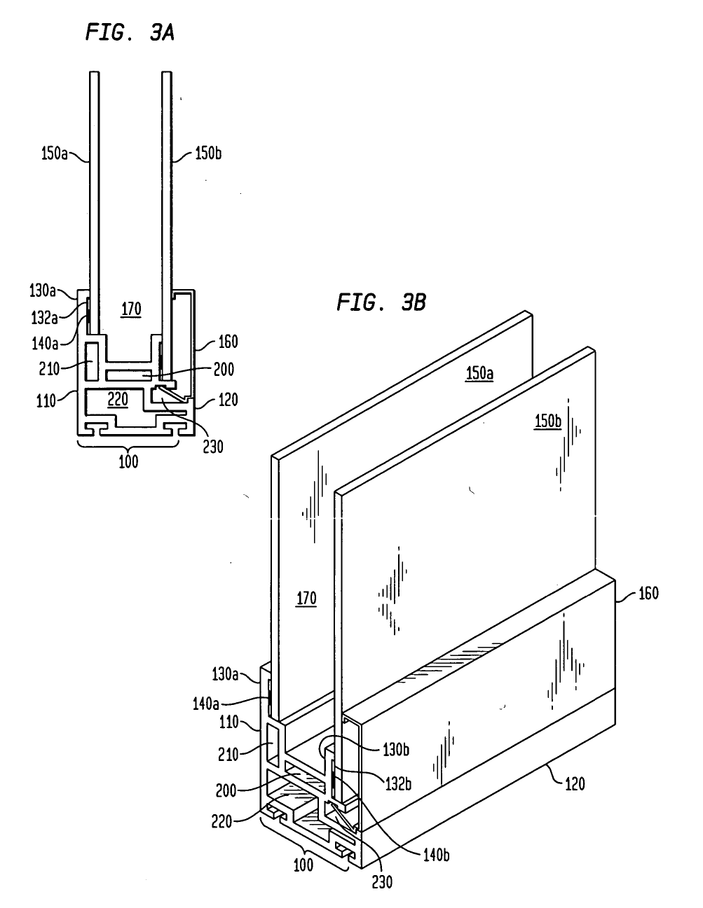

FIGS. 3A and 3B show a cross-sectional view and perspective view, respectively, of one embodiment of a hollow sash of the present invention, again including integral spacer frames therein. As described above, a hollow sash 100 has a first viewing surface 110 and a second viewing surface 120, whereupon a first bonding recess 130a and second bonding recess 130b are placed respectively. Bonding materials 140a and 140b are coupled to glass panes 150a and 150b at the bonding surfaces 132a and 132b of the bonding recesses 130a and 130b, respectively. A glazing bead 160 is applied at the second viewing surface 120 against the bonding recess 130b and glass pane 150b. The glazing bead is coupled to the sash frame 100, for example, by means of a glazing bead lock 230, which serves to latch the glazing bead 160 to the sash frame 100.

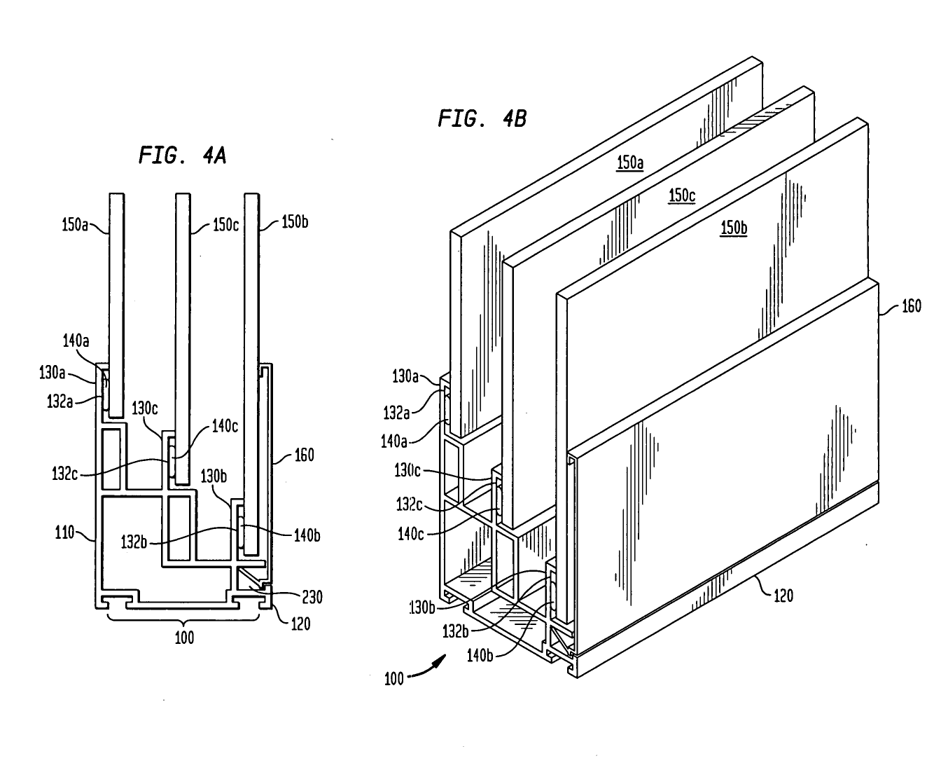

Referring next to FIGS. 4A and 4B, a triple-glazed window is shown which employs a third bonding recess which is added to the region of the sash 100 within the central insulting region 170, and once again with this third bonding recess facing in the same direction as the first and second bonding recesses. In particular, in the case of FIGS. 4A and 4B, a hollow sash 100 has a first viewing surface 110 and a second viewing surface 120. In this case, a first bonding recess 130a is located at the first viewing surface 110 and faces the second viewing surface 120. A second bonding recess 130b is located at the second viewing surface 120 and also faces that second viewing surface 120. A third bonding recess 130c is located between the first and second bonding recesses, 130a and 130b, respectively, and once again faces the second viewing surface 120. Bonding materials 140a, 140b and 140c are coupled to glass panes 150a, 150b and 150c, respectively, at the bonding surfaces 132a, 132b and 132c of respective bonding recesses 130a, 130b and 130c. A glazing bead 160 is once again applied at the second viewing surface 120 against the bonding recess 130b and glass pane 150b. The glazing bead is once gain coupled to the sash frame 100, for example, by means of a glazing bead lock 230, which serves to latch the glazing bead 160 to the sash frame 100. Additional bonding recesses could also be added to the region of the sash 100 within the actual insulating region 170, once gain so long as each of these additional bonding recesses faces the same direction as the first, second and third bonding recesses.

The central insulating region 170 may include desiccant material (not shown) to absorb moisture accumulated in the insulated region 170.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for glazing an insulated sash frame for an insulated glass window, comprising:
laying an insulated sash frame having an outer surface on a first viewing side of said insulated sash frame, said insulated sash frame including said first viewing side, a second viewing side, and a plurality of bonding recesses all opened toward said second viewing side of said insulated sash frame;
applying a bonding material to each of said plurality of bonding recesses from said second viewing side; and,
setting a glass piece on each of said plurality of bonding recesses from said second viewing side.

2. The method of claim 1, further comprising:
varying the distance between each of said plurality of bonding recesses and said outer surface of said insulated sash frame.

3. The method of claim 1, wherein said plurality of bonding recesses include:
a first bonding recess on said first viewing side of said insulated sash frame, said first bonding recess facing said second viewing surface of said sash frame, and
a second bonding recess on said second viewing side of said insulated sash frame, said second bonding recess facing said second viewing surface of said sash frame.

4. The method of claim 2, further comprising:
applying a glazing bead to said second viewing side of said insulated sash frame.

5. A method of claim 1, wherein said plurality of bonding recesses include:
a first bonding recess in said first viewing side of said insulated sash frame, said first bonding recess facing said second viewing surface of said sash frame,
a second bonding recess on said second viewing side of said insulated sash frame, said second bonding recess facing said second viewing surface of said sash frame, and
a third bonding recess between said first bonding recess and said second bonding recess, said third bonding recess facing said second viewing surface of said sash frame.

6. A method for glazing an insulated sash frame for an insulated glass window, comprising the steps of:
laying an insulated sash frame on a first viewing side of said insulated sash frame, said insulated sash frame including said first viewing side, a second viewing side, a first bonding recess on said first viewing side, and a second bonding recess on said second viewing side, said first and second bonding recesses open to said second viewing side of said insulated sash frame;
applying a bonding material to said first bonding recess of said insulated sash frame from said second viewing side;
applying a bonding material to said second bonding recess of said insulated sash frame from said second viewing side;
setting a glass piece on said first bonding recess of said insulated sash frame from said second viewing side; and,
setting a glass piece on said second bonding recess of said insulated sash frame from said second viewing side.

7. The method of claim 5, further comprising:
applying a glazing bead to said second viewing side of said insulated sash frame from said second viewing side.

8. An insulated sash frame having first and second viewing sides and a base for an insulated glass window, comprising:
a first bonding recess on said first viewing side, said first bonding recess open to said second viewing side, and having a first elevation from said base; and,
a second bonding recess on said second viewing side, said second bonding recess open to said second viewing side, and having a second elevation for said base, said first and second elevations being different.

9. The frame of claim 8, wherein said first elevation is greater than said second elevation.

10. The frame of claim 8, further comprising:
a first bonding material applied to said first bonding recess; and,
a second bonding material applied to said second bonding recess.

11. The frame of claim 10, further comprising:
a first glass pane coupled to said first bonding recess by means of said first bonding material; and,
a second glass pane coupled to said second bonding recess by means of said second bonding material.

12. The frame of claim 10, further comprising:
a glazing bead, said glazing bead secured to said second viewing surface and at least partially covering said second glass pane, said glazing bead having a glazing bead elevation.

13. The frame of claim 12, wherein said glazing bead depth is approximately the same as said first elevation.

14. The frame of claim 8 including a third bonding recess between said first bonding recess and said second bonding recess, said third bonding recess open to said second viewing side, and having a third elevation for said base, said third elevation being different from said first and second elevations.

15. The frame of claim 14 wherein said first elevation is greater than said third elevation, ad said third elevation is greater than said second elevation.
